(19) United States
(12) Patent Application Publication
(10) Pub. No.: US 2009/0094538 A1
(43) Pub. Date: Apr. 9, 2009

(54) METHOD FOR CREATING TABLES IN ELECTRONIC FORMS

(76) Inventor: Marcel K. Ringler, Ruschlikon (CH)

Correspondence Address: MOETTELI & ASSOCIATES SARL, ST. LEONHARDSTRASSE 4, ST. GALLEN, CH-9000, CH

(21) Appl. No.: 12/281,992

(22) PCT Filed: Mar. 9, 2007
(86) PCT No.: PCT/IB2007/000575

§ 371 Date: Sep. 8, 2008

Related U.S. Application Data
(60) Provisional application No. 60/780,753, filed on Mar. 9, 2006.

(51) Int. Cl. G06F 3/048; G06F 3/00

(52) U.S. Cl. 715/760; 715/810; 715/786

(57) ABSTRACT

A form table system and method are disclosed, for creating fillable form tables that are part of electronic documents. The form tables may include an unlimited number of cell array vectors, e.g., rows or columns, confined to a limited space in the electronic document. The form table system enables a user to quickly and easily generate a form by placing a table object on a form page, populating the table object with other desired objects, and defining \characteristics, such as row height and number of visible rows for the form table. As the form is filled in with data, where the number of entered rows exceeds the number of visible rows, the form table extends such that the document is printed in its original form, but the additional information is still available both for viewing and for printing.

### CROSS-REFERENCE TO RELATED APPLICATIONS

This invention claims priority to U.S. Provisional Patent Application No. 60/780,753, filed on Mar. 9, 2006, the disclosure of which is incorporated herein by reference, as if set forth in its entirety.

### FIELD OF THE INVENTION

This invention relates to electronic form processing and, in particular, the creation of tables to be used in electronic forms.

### BACKGROUND OF THE INVENTION

Systems and methods exist which facilitate the design of visual grids and for the design of charts or tables. For example, Microsoft has a product called Infopath, Adobe offers the Adobe Acrobat Form Designer and Adobe (formerly Macromedia) Flash and Cold Fusion. A product called Filemaker exists, as well as Verity/Cardiff, PureEdge, Primary Software's VisiForm, Miraplacid, and Smartform GmbH (Switzerland).

One of the most popular among these is Adobe Acrobat™. Acrobat™ creates forms in Portable Document Format (PDF). PDF is a proprietary file format developed by Adobe Systems. This format represents two-dimensional documents in a resolution- and device-independent manner. Each PDF file encapsulates a more complete description of a 2D document than a typical text document. PDF files typically include text, fonts, images, and 2D vector graphics that compose the document. The term vector graphics is one of several modes a programmer may use to create an image on a raster display.

Importantly, PDF files don't encode information that is specific to the application software, hardware, or operating system used to create or view the document. This feature ensures that a valid PDF will render exactly the same regardless of its origin or destination.

Therefore, PDF files are most appropriately used to encode the exact look of a document in a device-independent way. While the PDF format may describe very simple one-page documents, it may also be used for many-page, complex documents that use a variety of different fonts, graphics, colors, and images.

Despite significant advantages, none of these products enable the free-form creation of tables that, no matter how many rows, fit within a defined grid of a form and which may be fixed with respect to the background image. U.S. Pat. No. 6,993,527, entitled “Describing Documents and Expressing Document Structure”, is incorporated herein by reference thereto, for background information in the art.

### SUMMARY OF THE INVENTION

A form table system and method are disclosed, for creating fillable form tables that are part of electronic documents. The form tables may include an unlimited number of rows, columns, or other cell array vectors confined to a limited space in the electronic document. The form table system enables a user to quickly and easily generate a form by placing a table object on a form page, populating the table object with other desired objects, and defining the row height and number of visible rows for the form table. As the form is filled in with data, where the number of entered rows exceeds the number of visible rows, the form table extends such that the document is printed in its original form, but the additional information is still available both for viewing and for printing.

The form table system includes several features to facilitate the rapid creation of the form table, the easy-to-understand presentation of the form table to a display, and the printability of the form table, which, despite the dynamic sizing of the form table, conforms to the size limitations of the electronic document. The additional form table listings are dynamically generated, based on the entered data in relation to the specified properties of the form table.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein like reference numerals refer to like parts throughout the various views, unless otherwise specified.

FIG. 1 is a block diagram of a form table system, according to some embodiments.

FIGS. 2A-2P are screen prints of a GUI, showing various features of the form table system of FIG. 1, according to some embodiments.

FIGS. 3A-3E are block diagrams of a document using form tables generated by the form table system of FIG. 1, according to some embodiments.

FIG. 4 is a flow diagram illustrating operation of the form table system of FIG. 1, according to some embodiments.

FIG. 5 is a block diagram of a processor-based system using the form table system of FIG. 1, according to some embodiments.

### DETAILED DESCRIPTION OF THE PREFERRED EMBODIMENTS

In the following detailed description, reference is made to the accompanying drawings, which show by way of illustration specific embodiments in which the invention may be practiced. However, it is to be understood that other embodiments will become apparent to those of ordinary skill in the art upon reading this disclosure. The following detailed description is, therefore, not to be construed in a limiting sense, as the scope of the present invention is defined by the claims.

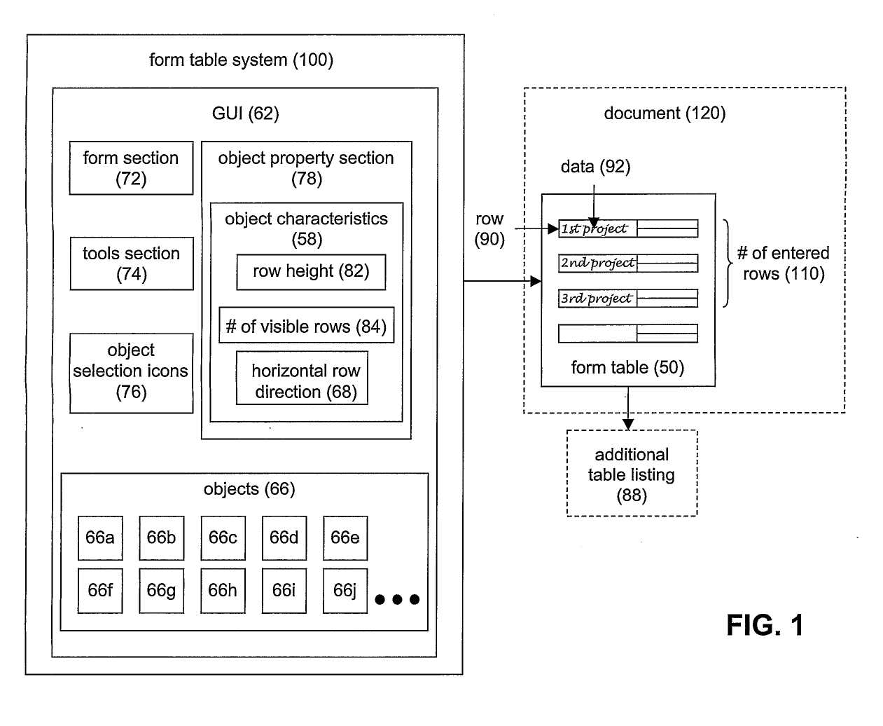

FIG. 1 is a block diagram of a form table system 100 used to generate a form table 50, according to some embodiments. The form table system 100 includes a graphical user interface (GUI) 62 for interfacing with a user of the form table system 100. The GUI 62 optionally includes a form section 72, a tools section 74, object selection icons 76, an object property section 78, and a plurality of objects 66, each of which enables the user to quickly and easily generate the form table 50 suitable for a particular task for a business or an enterprise.

As used herein, the form table 50 is defined as a table having one or more identical cell array vectors 90, each cell array vector being characterized by one or more objects 66. Cell array vectors 90 may be rows, columns, or other repeatable sections, such as where the form table 50 has radially extending cell array vectors. For simplicity, the drawings depict cell array vectors 90 as rows. Reference to rows 90, in both the drawings and in the specification, is meant to encompass any type of cell array vector. Further, reference to row height 82, number of visible rows 84, and number of entered rows 110 may be generalized as cell array vector height 82 (or other dimension), number of visible cell array vectors 84, and number of entered cell array vectors 110, which may include columns or other units. Software designers of ordinary skill in the art recognize a number of ways in which the form table may be characterized using repeatable sections. The form table 50 in FIG. 1 includes one or more rows 90, in which the rows 90 are filled with data 92.

The form table system 100 enables the user to generate the form table 50 by defining the row 90 of the form table using objects 66. Accordingly, the form table system 100 includes many objects 66 of various types suitable for different types of forms that may be desired. The number of different types of objects 66 may be quite large. In some embodiments, the objects 66 enable the user to include in the form table 50 one or more of the following: a line, a rectangle, a cover, an image, a label, a hyperlink, an information point, a text field, a numeric field, a date field, a masked input field, a multiple line text field, a checkbox field, a combination box field, a password field, a radio buttons group, a table field, and a barcode field (of which there may be multiple types). The objects 66 may include any of a variety of other dynamic or static objects 66 representing information. The table object 66 is used to create the row 90, which, in turn, is used to build the form table 50.

The object property section 78 includes object characteristics 58 associated with each of the objects 66 being used to generate the form table 50. The user of the form table system 100 may adjust the object characteristics 58 in generating the form table 50. In particular, three properties, row height 82, number of visible rows 84, and horizontal row direction 68, are described in more detail, below. The object property section 78 is likely to have many more properties than are illustrated in FIG. 1. However, as will be shown, the form table system 100 enables the user to quickly and easily generate the form table 50 by selecting a desired number of objects 66 and adjusting the row height 82 and the number of visible rows 84.

The form table 50 may optionally be part of a document 120, as depicted in FIG. 1. The user (perhaps a different user than the user who generated the form table 50) may enter data 92 into the form table 50, such that an other characteristic of the form table 50, the number of entered rows 110, is known. The form table system 100 is capable of automatically and dynamically presenting the form table 50, such as to a display, and printing the form table 50, so that, where the form table 50 is limited to a predefined space allocation within the document 120, the form data 92 is nevertheless available for viewing (on the display) or printing (to a printer). The availability of the form data 92 may be within the predefined allocated space of the document 120, or it may be visible on an additional table listing 88, as described in more detail, below.

In some embodiments, the form table system 100 is a software program. The software program, when opened or executed, presents the GUI 62 to a screen, such as a computer display. (A system 20 for using the form table system 100 is described further in FIG. 10, below.) Accordingly, the form table system 100 may also be referred to herein as the form table software program 100.

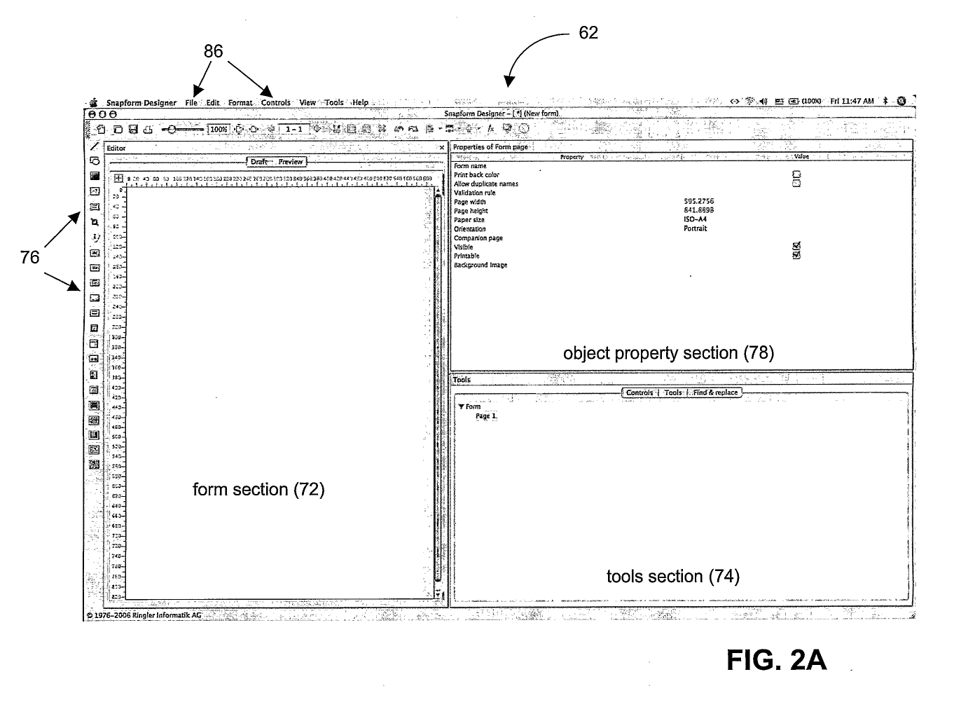

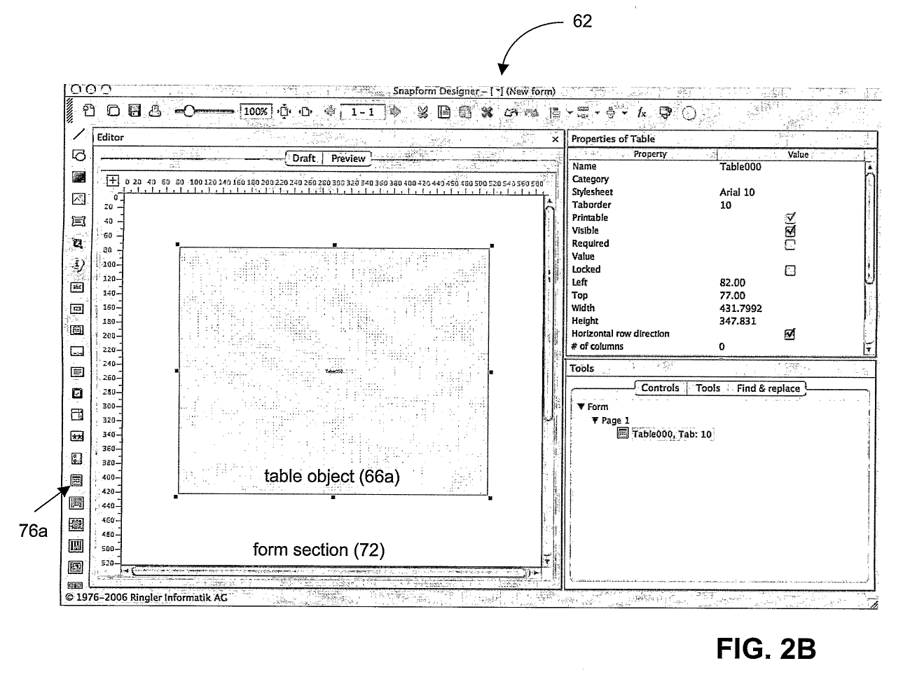

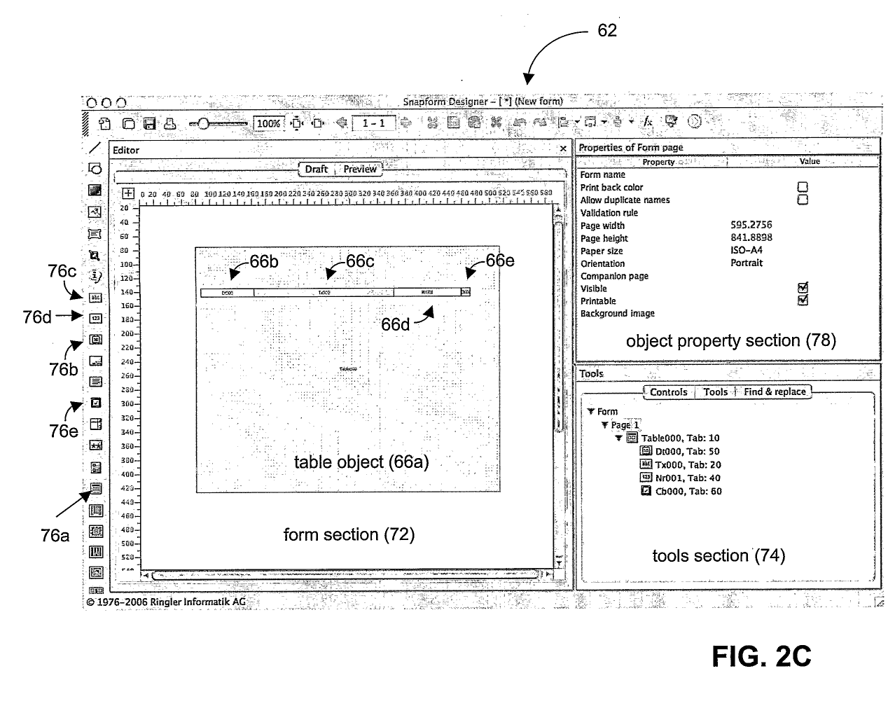

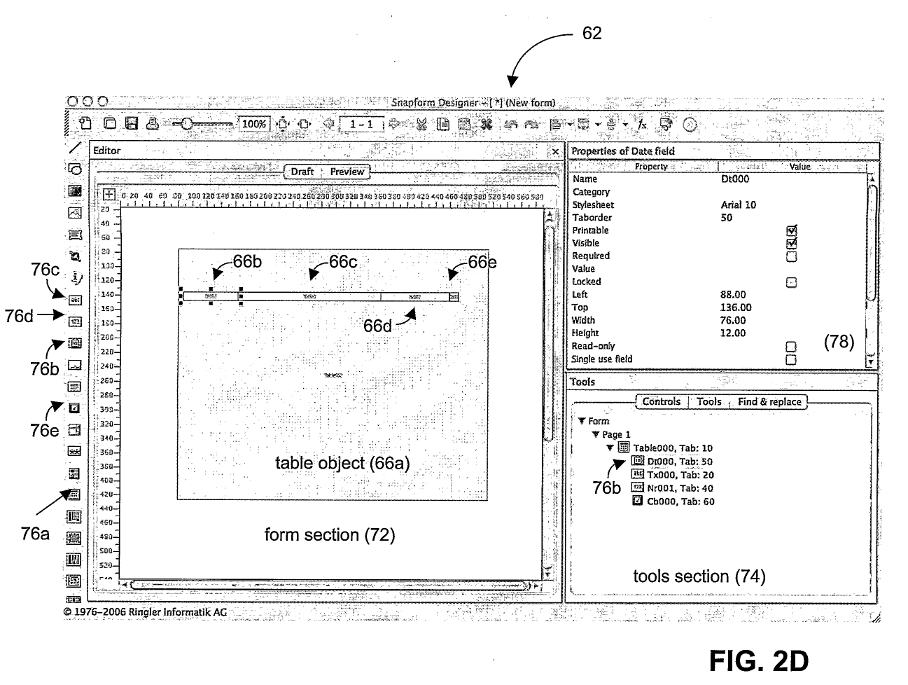

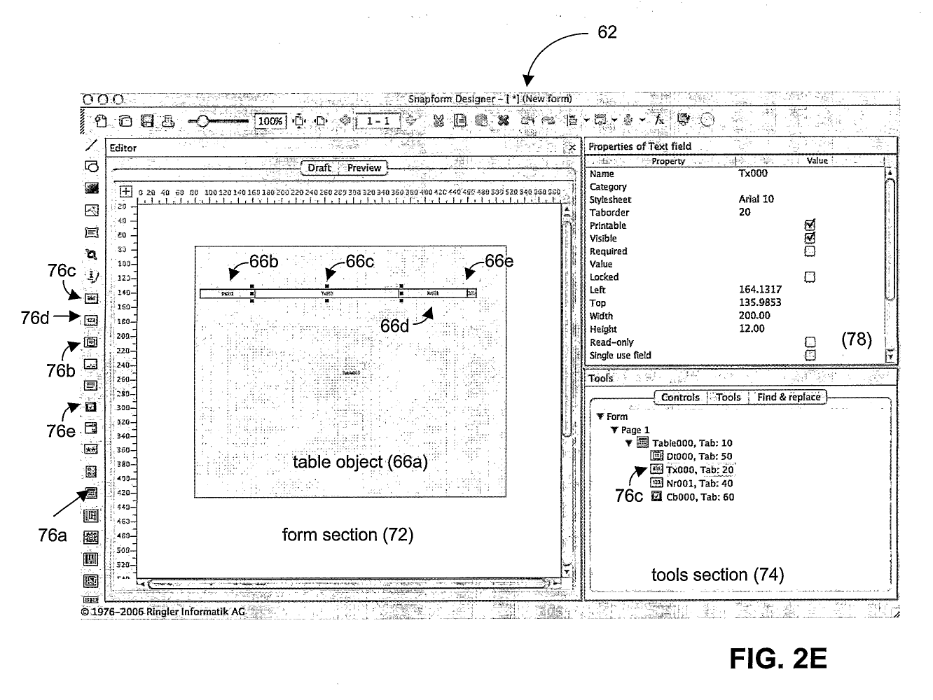

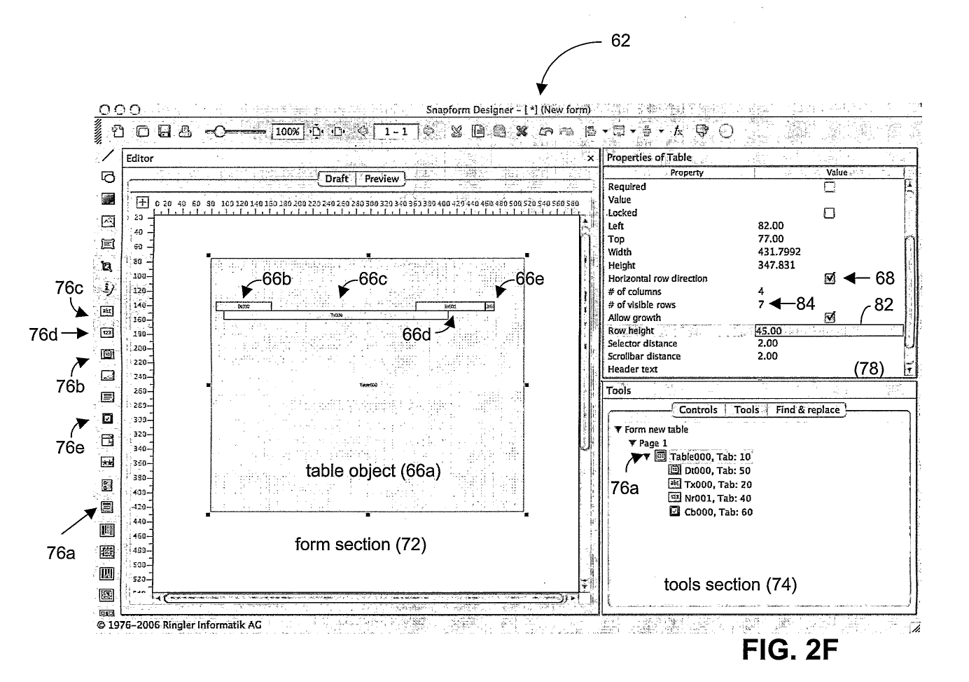

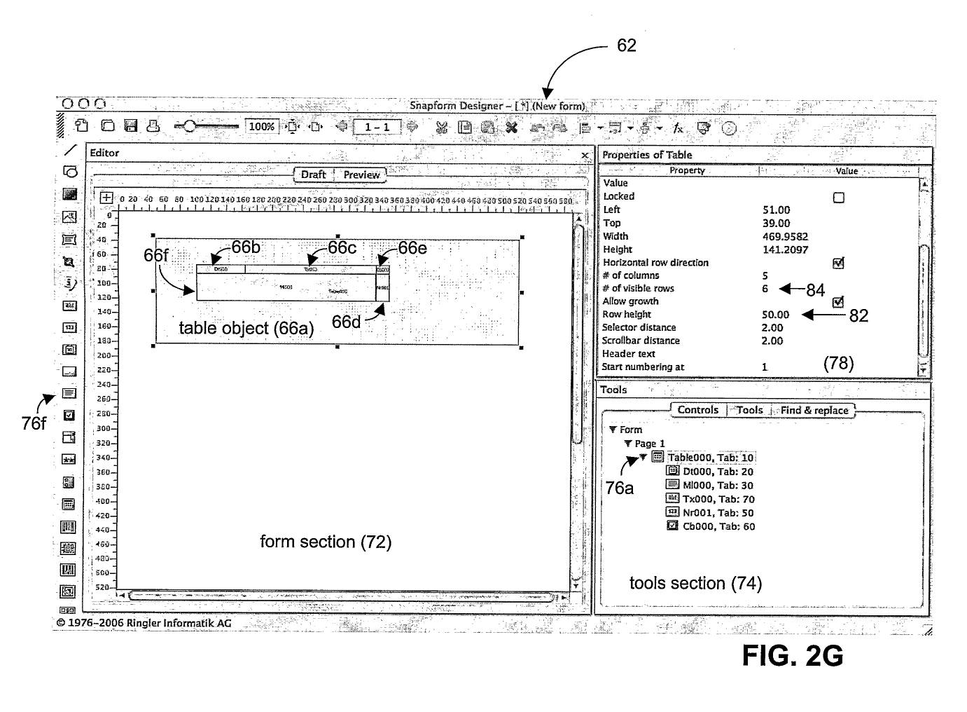

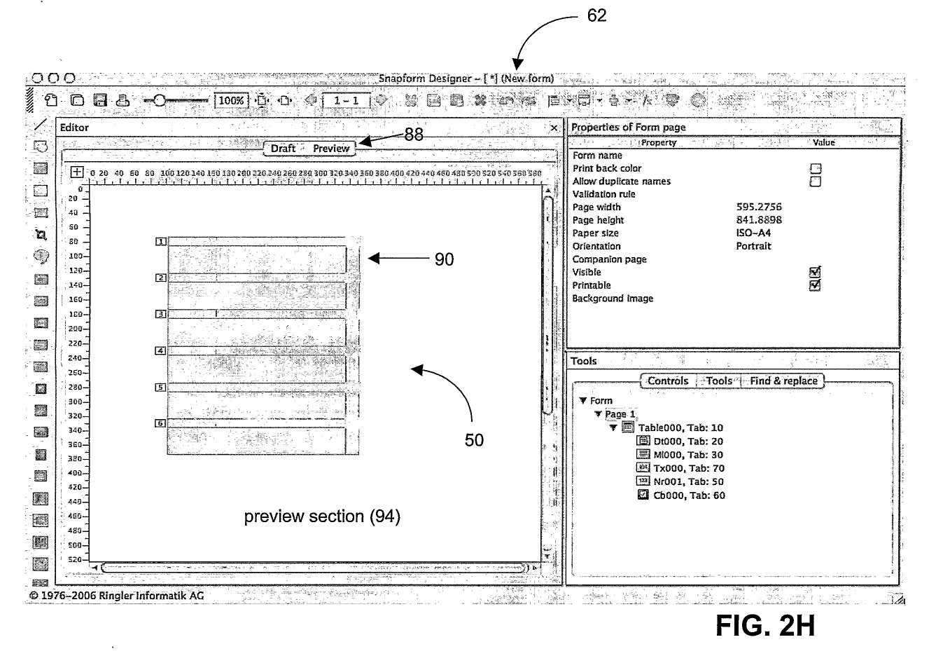

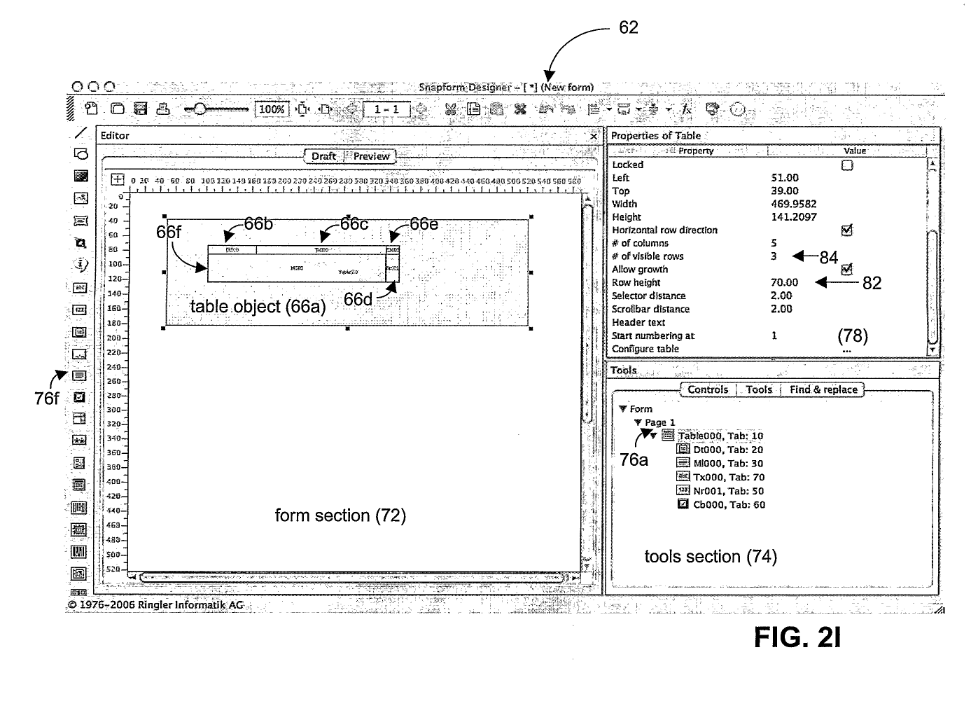

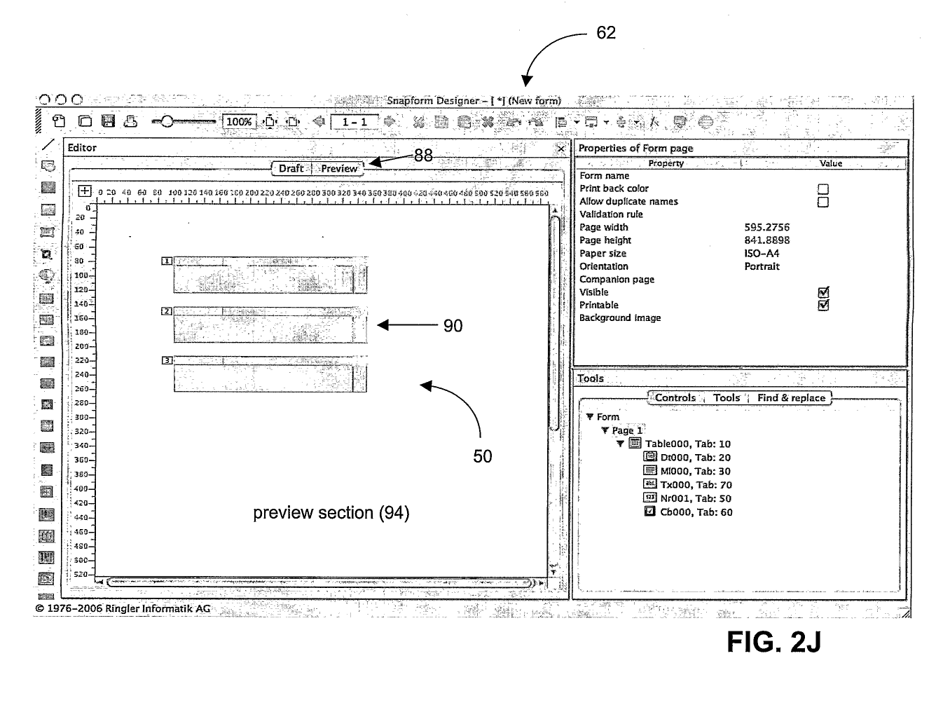

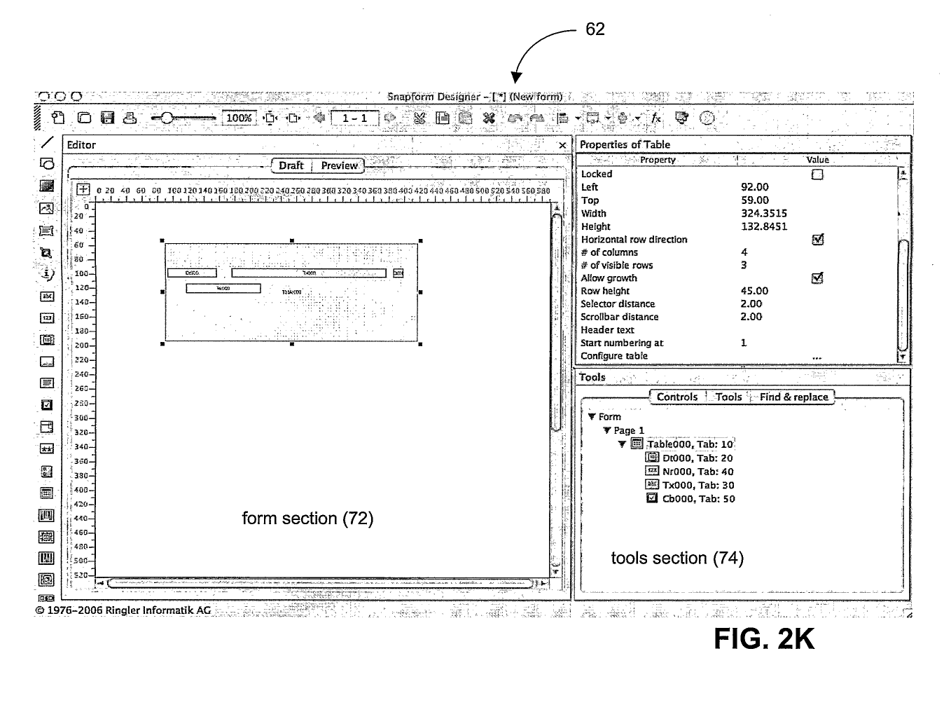

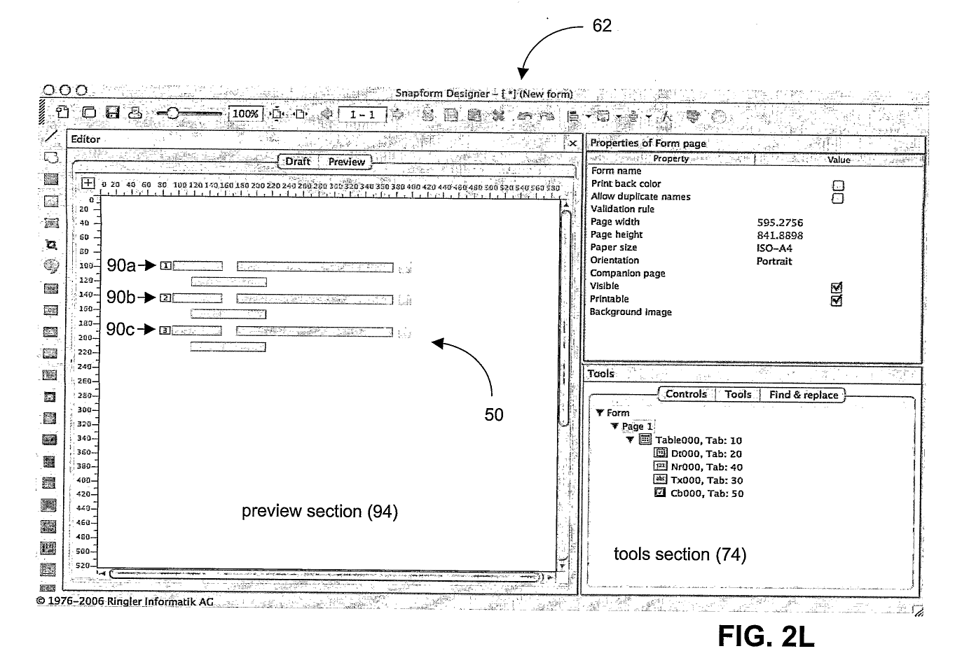

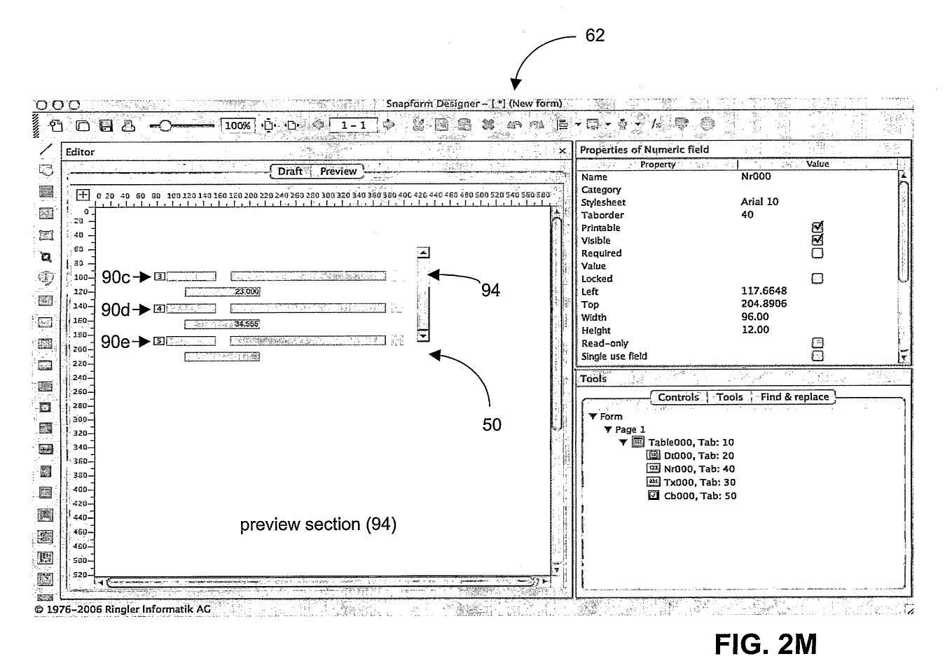

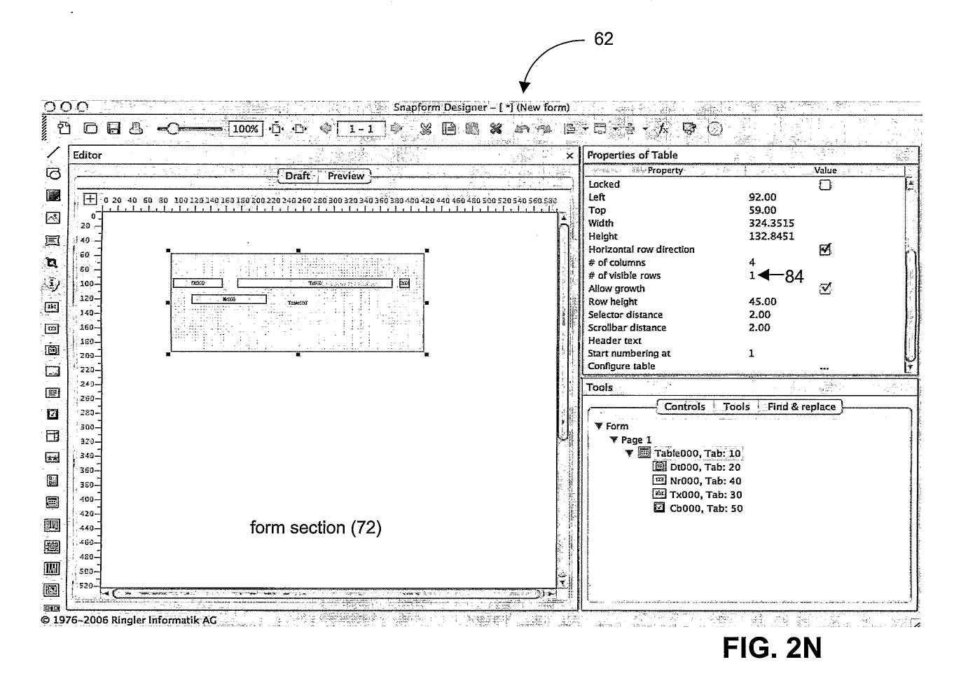

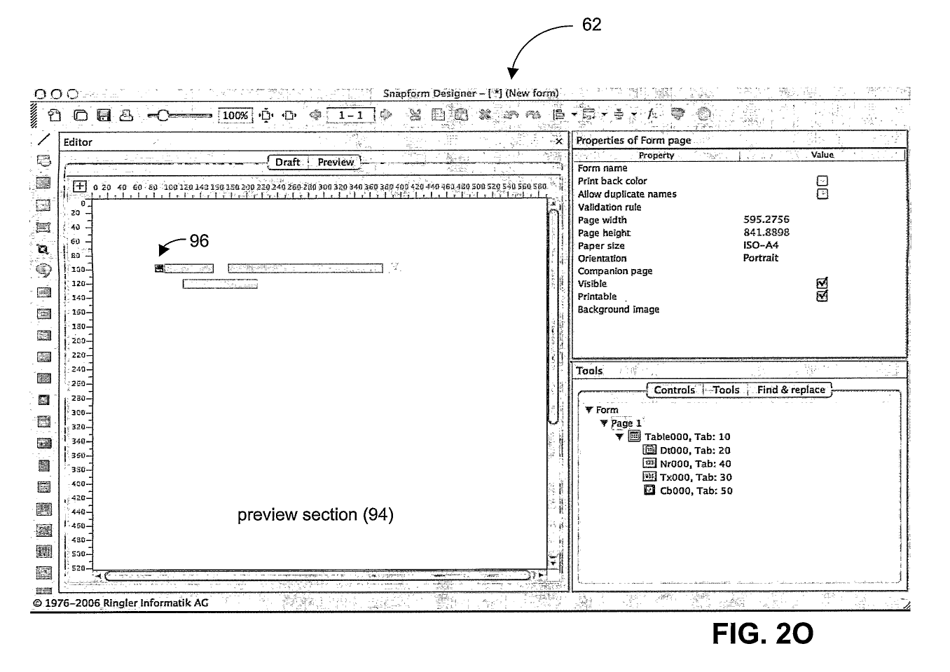

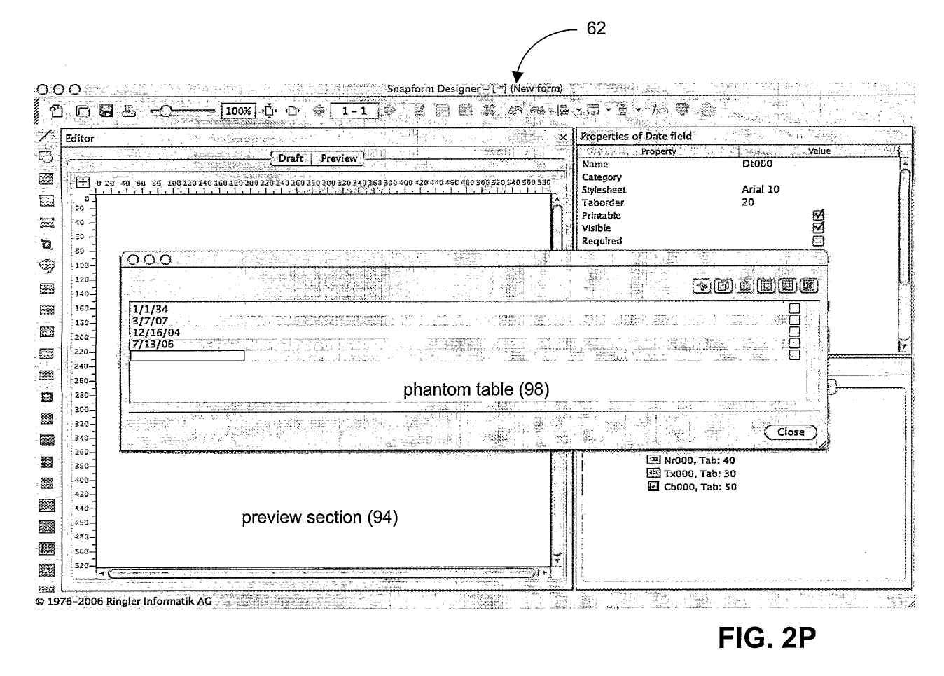

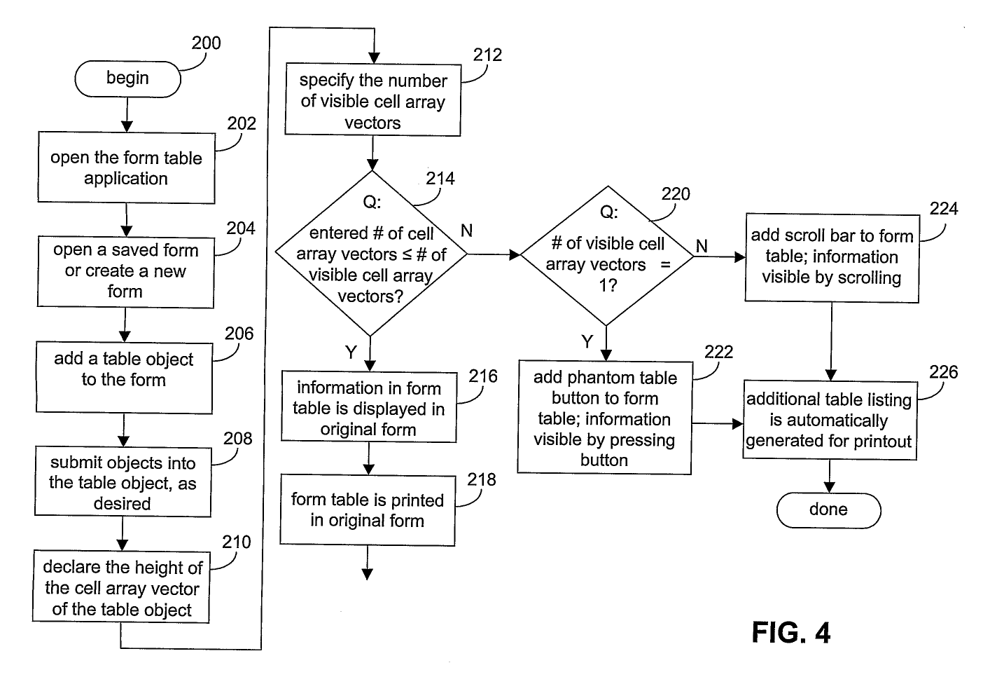

Referring to FIGS. 2A-2P, several screen prints of a particular GUI 62 of the form table system 100 are presented. The screen prints are provided to facilitate understanding of particular aspects of the invention. However, the screen prints merely represent particular embodiments of the form table system 100 and are not meant to limit other possible implementations that may be used. Following the presentation of several example screen prints, a flow diagram (FIG. 4), illustrates the method of operating the form table system 100.

One implementation of the GUI 62 is depicted in FIG. 2A, according to some embodiments. The GUI 62 includes a series of commands 86, with sub-commands accessible using pull-down menus. The commands 86, among other tasks, enable the user to create a form or open a new form, edit an existing form, format the form, and so on. The three sections of the GUI 62 introduced in FIG. 1, the form section 72, the object property section 78, and the tools section 74, are also depicted. Along one side of the GUI 62, the object selection icons 76 are used to select associated objects 66 to be presented to the form section 72.

FIG. 2B is a screen print of the GUI 62, in which a table object 66a is selected by clicking on the table icon 76a, as shown. The table object 66a is presented to the form section 72 of the GUI 62.

In an alternate embodiment, the form table system 100 enables the user to place the objects 66 in the form section 72 without first having to select and enter the table object 66a. Instead, each object 66 may have an object property, as specified in the object property section 78, which indicates the association of the object with the table.

FIG. 2C is a screen print of the GUI 62, in which the table object 66a is populated with a date object 66b, a text object 66c, a number object 66d, and a checkbox object 66e. Each of the objects 66 is presented to the table object 66a by selecting one of the associated icons 76b, 76c, 76d, and 76e. The user may arrange the objects 66 anywhere in the table object 66a (or, in lieu of the table object 66a, in the form section 72).

In the object property section 78 of the GUI 62, the user may adjust various characteristics 58 of the objects 66 contained within the form section 72. The tools section 74 identifies which part of the form section 72 may be modified (in the object property section 78). In FIG. 2C, the part of the form table 50 specified as “Page 1” is highlighted. The user may enter a “form name” in the object property section 78, as well as modify other characteristics of the form table 50, such as whether the form table 50 is presented in portrait or landscape orientation.

In FIG. 2D, the date object 66b is highlighted (as indicated by small square marks surrounding the field). The date object 66b may be selected by clicking on the object itself or by selecting the date object icon 76b in the tools section 74. As soon as the date object 66b is selected, the fields in the object property section 78 change to pertain to the date object 66b. The user may change the properties of the date object 66b by selecting the relevant field of the object property section 78. For example, the width and height of the date object 66b are specified as “76.00” and “12.00”, respectively. These characteristics may be changed while the date field icon 76b is highlighted in the tools section 74 (e.g., when the date object 66b is highlighted in the forms section 72).

In FIG. 2E, the text object 66c is highlighted. Accordingly, the text icon 76c is highlighted in the tools section 74 of the GUI 62, and the object property section 78 pertains to the properties of the text object 66c. A user may change the properties of the text object 66c by selecting one of the fields in the object property section 78. The form table system 100 thus facilitates the creation of the form table 50 using the GUI 62, which enables the user to readily populate the table object 66a with other desired objects, each of which may conform to particular desired characteristics of the form table being created.

In some embodiments, the objects 66 are not lined up, as in FIGS. 2C-2E. Each of the objects 66 placed in the table object 66a define a first row of the form table 50. Thus, the objects 66 define the logical row structure for the form table 50.

Recall from FIG. 1 that the object property utility 68 of the form table system 100 includes three object characteristics 58: the row height 82, the number of visible rows 84, and the horizontal row direction 68. The three characteristics 58, the horizontal row direction 68, the row height 82, and the number of visible rows 84, are visible in the screen print of FIG. 2F. The horizontal row direction 68 enables the user to determine whether the rows 90 are presented vertically in the form table 50 or horizontally in the form table.

FIGS. 2G-2J are screen prints of the GUI 62 and show how specifying the row height property 82 and the number of visible rows property 84 changes the form table 50. In FIG. 2G, a table object 66a includes a date object 66b, a text object 66c, a number object 66d, and a checkbox object 66e, as well as a multiple line text object 66f (obtained by selecting icon 76f). The objects within the table object 66a specify the characteristics of the first row 90 of the form table 50. As indicated in the object property section 78, the row height 82 is “50.00” and the number of visible rows 84 is “6”.

Once the characteristics 58 for the form table 50 have been specified, the user may preview the form table, as in FIG. 2H. A selected preview button 88 causes a new section, a preview section 94, to be visible in the GUI 62. A preview of the form table 50 is shown, with “6” visible rows 90, each row having a height of “50.00”, as specified in the object property section 78.

In FIG. 21, the table object 66a is again shown. This time, in the object property section 78, the number of visible rows 84 is specified as “3” while the row height 84 is “70.00”. A preview of the form table 50, shown in FIG. 2J. The number of visible rows is “3” this time, and the row height, being “70.00” rather than “50.00” in FIG. 2H, results in there being more space between the rows 90.

The number of visible rows characteristic 84 indicates to the form table system 100 how many visible rows are to appear on the form table 50 during runtime operation. Although the form table 50 may accept virtually an endless number of rows, the visible part of the form is defined by the number of visible rows characteristic 84. Where the form table 50 has more rows than are defined by the characteristic 84, the additional rows 90 are visible after scrolling the form. If no row height 82 or number of visible rows 84 is specified by the user, in some embodiments, a default value is used.

The scroll bar 94 and phantom table button 96 are illustrated in FIGS. 2K-2P, according to some embodiments. In FIG. 2K, the GUI 62 is depicted, with a table object 66a having a date object 66b, a text object 66c, a number object 66d, and a checkbox object 66e, as shown in the form section 72. The object property section 78 shows that the number of visible rows 84 is “3” and the row height 82 is “45.00”. In FIG. 2L, a preview of the form table 50 shows three rows, 90a, 90b, and 90c, with height of “45.00”. In FIG. 2M, the GUI 62 shows that when the rows are completed with data 92, such as by filling in the number object 66d, a new row 90d is added, a new row 90e, and so on. Also, a scroll bar 94 is depicted, so that the user can navigate through the form table 50, as needed. Since the number of visible rows 84 is specified as “3”, there are only three rows visible at any time.

Sometimes, the document 120 including the form table 50 has room for only a single row. In FIG. 2N, for example, the number of visible rows 84 is specified as “1”. A preview of the form table 50, shown in FIG. 20, shows the form table 50 with a single row (having all the objects specified in the table object 66a in FIG. 2N). Instead of having a scroll bar 94, the preview section 94 features a new icon, a phantom table button 96. The phantom table button 96 indicates that there is another table containing the additional information. The user may select the phantom table button 96, causing a phantom table 98, as depicted in FIG. 2P, to emerge. The phantom table 98 may be completed with data 92 (in this case, date information), just as if the table was part of the form.

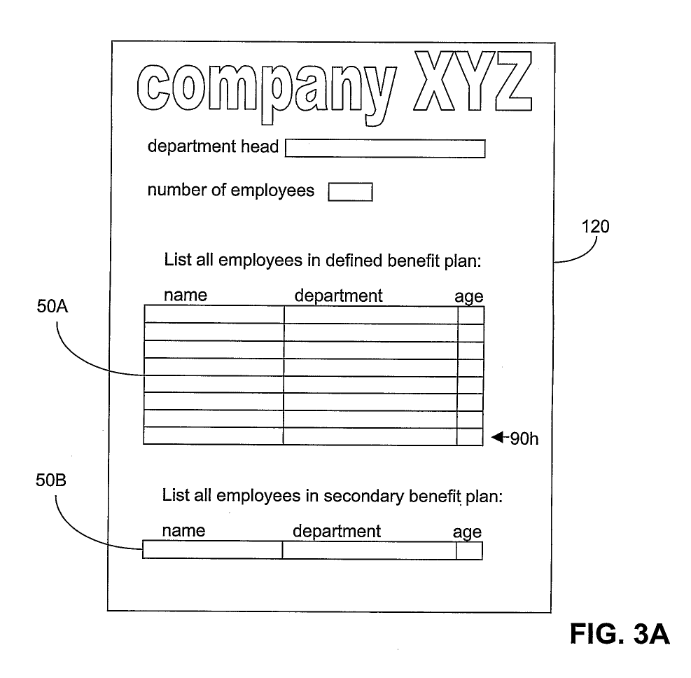

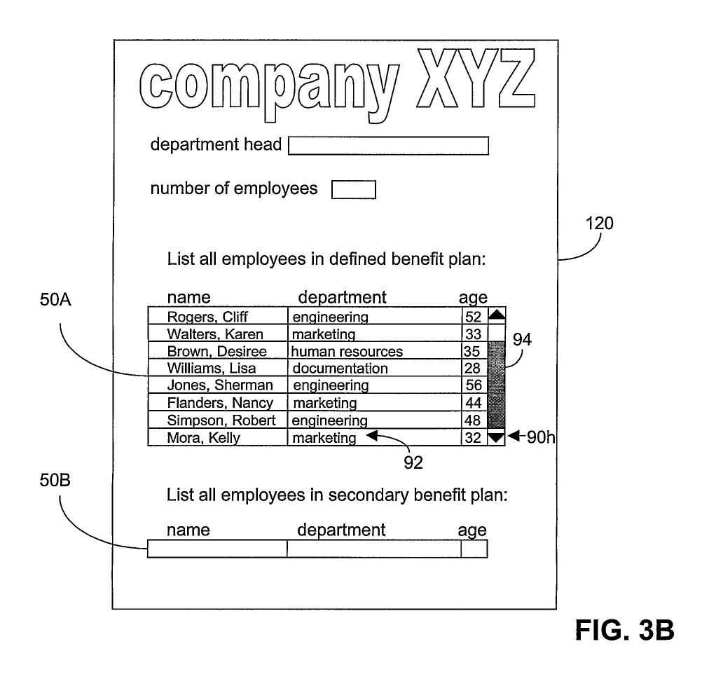

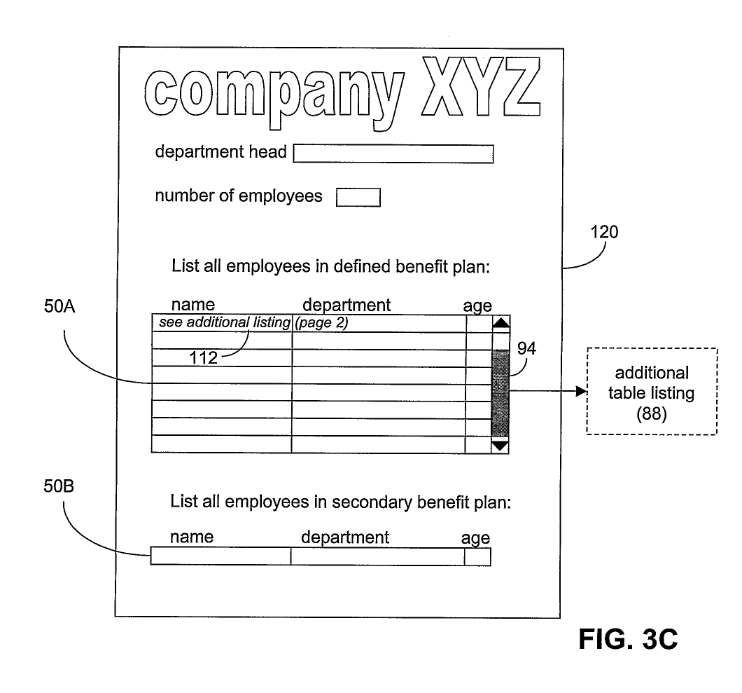

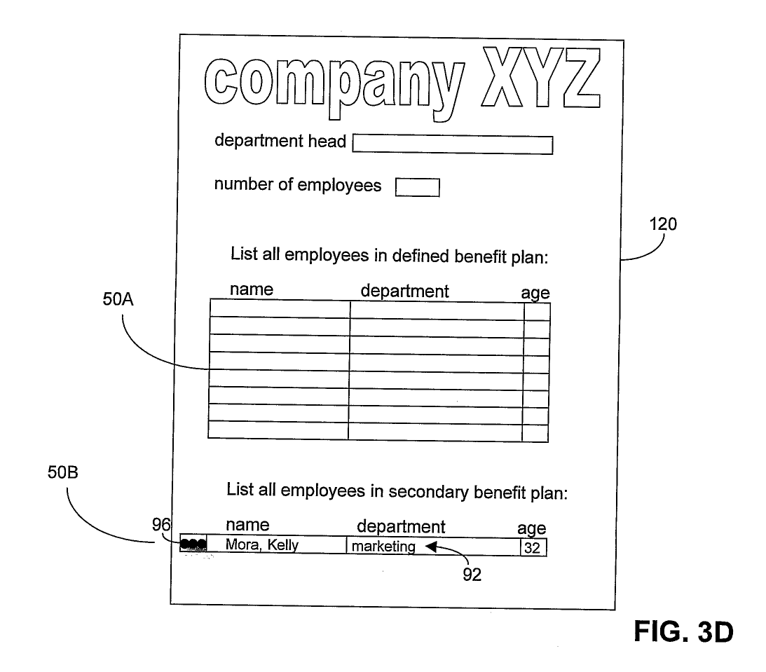

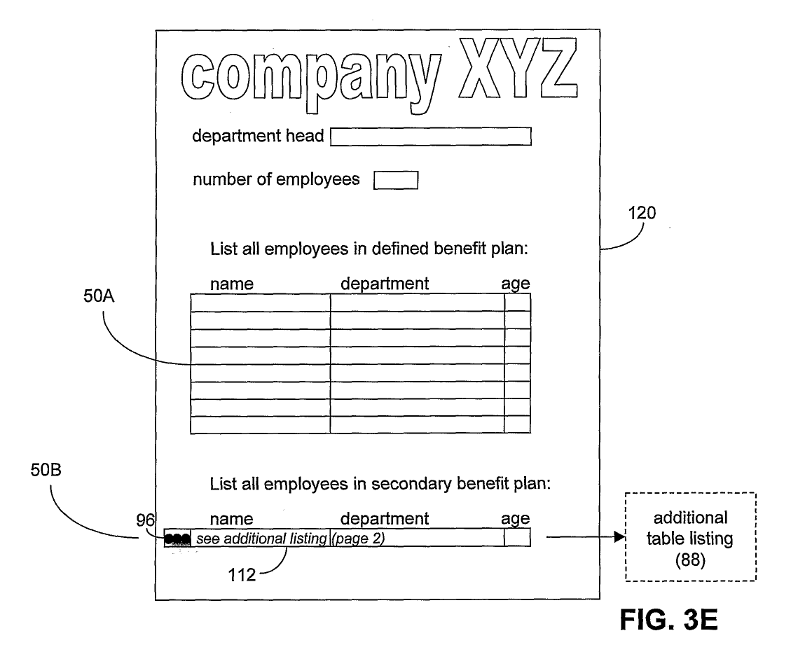

Recall from FIG. 1 that the form table 50 may optionally be part of a document 120, such as is depicted in FIGS. 3A-3E, according to some embodiments. The document 120 is used by Company XYZ to keep track of employee benefits. The document 120 in FIG. 3A includes two form tables 50A and 50B. The document 120 may be part of a multiple-page form completed by an individual in the human resources department of Company XYZ, for example.

The form table 50A is filled in with the data 92, in this case, a list of all employees in a defined benefit plan of the company, including the name, department, and age of each. There are eight rows available in the form table 50A. By contrast, the form table 50B, which lists employees in a secondary benefit plan, includes only one available row.

The individual completing the document 120 is naturally going to want to include the pertinent data for all employees in company XYZ, whether there are less or more than eight employees in the defined benefits plan. The form table system 100 allows the form table 50A to grow as new entries are made. Thus, once the eighth row 90h is completed, a new row 90i (not shown) appears on the screen, such that information for a ninth employee may be entered. Simultaneously, a scroll bar 94 appears, indicating that the form table 50A has grown to more than eight rows. The scroll bar 94 is shown in FIG. 3B.

Where the document 120 is to be printed, the data 92 is replaced with an indicator 112, such as “see additional listing (page 2)”, as shown in FIG. 3C. The document 120 is printed in original form (with the number of rows 90 in the form 50A being as defined by the number of visible rows characteristic 84, and the data 92 is printed in the additional table listing 88. The additional table listing 88 is shown as optional because it is printed only if the number of entered rows 110 exceeds the specified number of visible rows 84.

The single-row form table 50B operates a little differently when the row is filled in, according to some embodiments. Where the single row of the form table 50B is filled in with the data 92, a phantom table button 96 appears. Like the scroll bar 94, the phantom table button 96 indicates to the user that additional information not currently visible in the form table 50B is available for viewing.

The phantom table button 96 is shown in FIGS. 3D and 3E. In FIG. 3D, a single row 90 of the data 92 is visible on the screen display, with the phantom table button 96 indicating that more data is available for viewing, by selecting the phantom table button 96. Where the data is to be printed, however, as shown in FIG. 3E, instead of seeing the data 92 in the form table 50B, the form table includes an indicator (112), such as “see additional listing (page 2)”, to indicate that the data 92 is to be printed in the additional table listing 88.

These features have the effect of extending one dimension for the form tables 50A and 50B, the visible rows and columns being the first and second dimensions, with the first dimension being expandable by either manipulating the scroll bar 94 or by selecting the phantom table button 96. The document 120 containing the form table 50 need not grow in the first and second dimensions during presentation (either displaying or printing). As the growth in the second dimension occurs, one of these additional indicators, the scroll bar 94 (where the form table 50 is a multiple-row table) or the phantom button 96 (where the form table 50 is a one-row table), will appear, as in FIGS. 3B and 3C, respectively, enabling the user to further obtain or provide table information without having the document 120 scroll to another page. During printing, as described below, the form table system 100 ensures that 1) the original sizing of the document 120 is preserved, and yet, 2) the complete table form 50, including all entered data 92, is presented in a print output.

FIG. 2 is a flow diagram 200, known herein as the form table method 200, including the operations performed by the form table system 100 in generating the form table 50, according to some embodiments. The above screen prints may be referred to as examples of one of many possible implementations of the method 200. The form table method 200 illustrates the ease with which the user may generate the form table 50 using the form table application 100. The operation commences with the form table application 100 being opened or executed, such that the GUI 62 is presented to the display (block 202). The user may open a saved form or create a new form (block 204). To create the table form 50, the user adds a table object 66a to the form section 72, by clicking on the table icon 76 (block 206).

The table object 66a may be populated with any of the available objects, which are readily accessible by selecting (i.e., clicking) one of the icons 76 (block 208). The icons 76 graphically represent the objects 66 to which each is associated. Each object 66 presented to the table object 66a represents a single row 90 of the form table 50 being generated. The objects 66 need not be aligned with one another, but may be presented anywhere within the table object 66a. In an alternative embodiment, objects 66 are submitted, not into a table object 66a, but directly into the form section 72. Each object may be placed anywhere within the table object 66a (or within the form section 72).

Once the desired objects for a given row of the form table 50 have been defined (by inserting them into the table object 66a), the user may specify a height for each row 90 (block 210). Where no row height 82 is specified, a default value is used, in some embodiments.

The user may also specify the number of visible rows 84 (block 212). The GUI 62 enables the user to specify the row height 82 for the form table 50 by first selecting the table object 66a in the form section 72 or by selecting the table icon 76a in the tools section 74 (see, e.g., FIG. 2F). This causes the object property section 78 to display properties for the table object 66a. The row height property 82, highlighted in the object property section 78, may be selected and changed by the user.

Once the row height 82 and the number of visible rows 84 has been specified (or default values used), the form table system 100 has enough information to generate the form table 50. The rest of the form table method 200 pertains to presentation of the form table 50 to a display and/or printing a document including the form table 50. Where the number of visible rows 82 is less than or equal to the number of rows entered by the user 110 (block 214), the data 92 in the form table 50 may be presented in its original form, since the number of rows 90 is sufficient to present all entered data 92 (block 216). Likewise, the form table 50 is printed in its original form. If the form table 50 is present in the document 120, the data 92 is printed along with the document, without any change to the characteristics of the document 120. If the form table 50 is not part of the document 120, then the form table 50 is printed just as defined, with the defined number of visible rows 84.

If, on the other hand, the number of rows with data 92 entered therein exceeds the number of visible rows 84 specified (block 214), then either a scroll bar 94 or a phantom table button 96 is displayed, depending on whether the form table 50 is a one-row form table (e.g., form table 50B in FIG. 3C) or a multiple-row form table (e.g., form table 50A in FIG. 3B). Where the form table 50 is a one-row form table (block 220), the phantom table button 96 is added to the form table 50, as well as an indicator 112, such as “see additional listing” (block 222). If, on the other hand, the form table 50 is a multiple-row form table, a scroll bar 94 is added to the form table 50, enabling the user to scroll through the form table to see all entries (block 224). Whether the form table is a single-row or a multiple-row form table, the additional table listing 88 is automatically generated when a print request is made (block 226).

In this way, the form table 50 prints in a precise manner each time it is printed, whether the form 50A or form 50B are populated with a number of entries exceeding the original designated amount or not. The scroll bar 94 and phantom table buttons 96 indicate whether the table entries exceed the predefined amount, such that there is no confusion to the user of the document.

In some embodiments, the column width of the additional table listing 88 may be obtained automatically, such as by calculating the width of each object within the table object 66a. The column width of the additional listing 88 is then, by default, proportional to the width of the objects. In some embodiments, the form table system 100 provides a mechanism by which the user may define page format and page orientation of the printout of the form 50 in a design or runtime mode. Further, in some embodiments, the user may adjust each column width of the form table 50 individually.

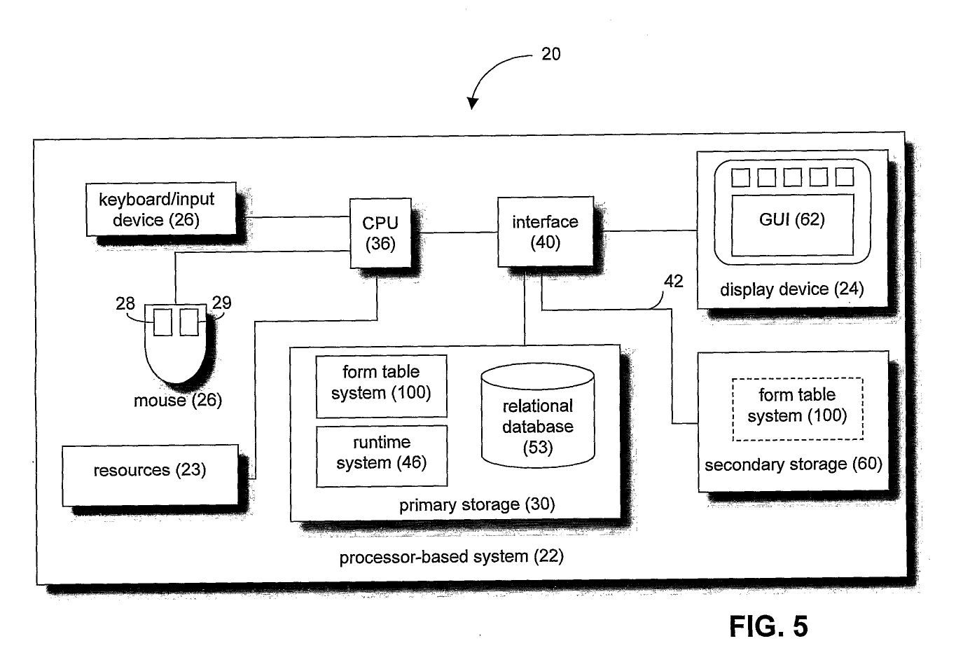

FIG. 5 is a block diagram of a typical system 20 for practicing the various embodiments of the form table system 100, including the form table method 200 described in FIG. 4. Recall that the form table system 100 may be a software program 100, which may be programmed using any of a number of software programs, languages, compilers, operating systems, and the like. In some embodiments, the form table system 100 is programmed using Java Runtime 1.4.2.

The computer system 20 includes a processor-based system 22, a display device 24, an input device 26 such as a keyboard, a primary storage device 30, a secondary storage device 32, and a plurality of resources 23. Each resource 23 is operatively coupled to the processor-based system 22. Resources 23 include, but are not limited to, printers, databases, special-purpose servers, security devices, modems, etc.

After the computer system 20 loads the form table system 100, the display device 24 displays the GUI 62, as described above, for facilitating the display of text and graphics for the user. The display device 24 may include a computer display screen, such as a cathode ray tube (CRT), light-emitting diode (LED), or liquid crystal display (LCD), to name a few. The input device 26 may include a keyboard and/or a pointing device, such as a mouse 27 having a left mouse button 28 and a right mouse button 29, as depicted in FIG. 10, and may further include, but is not limited to, a trackball, a light pen, a thumbwheel, a digitizing tablet, a microphone using voice recognition software, a touch screen, or a touch pad.

The processor-based system 22 includes a central processing unit (CPU) 36, as well as other components familiar to those of skill in the art. For a detailed discussion of these components and their interaction, see U.S. Pat. No. 5,787,254, the content of which is incorporated by reference. The primary storage 30 may include non-volatile media, such as a hard disk drive. The secondary storage 60 may include volatile media, such as random-access memory (RAM). The form table system 100 may be stored in the primary storage 30, then loaded into the secondary storage 60 during operation, as one example. The CPU 36 fetches computer instructions from the secondary storage 60 through an interface 40, such as an input/output subsystem connected to a bus 42. A relational database 53, including data and relations that are shared by users, is stored in the primary storage 30 and may be accessed via a file-server protocol.

In some embodiments, the processor-based system 22 is a computer, such as an “IBM APTIVA” computer, a product of International Business Machines Corporation of Armonk, N.Y., any computer compatible with the IBM PC computer systems, any of the “SPARC” station or “ULTRA” workstation computer systems available from Sun Microsystems, Inc. of Mountain View, Calif., or any “MACINTOSH” computer systems based on a “POWERPC” processor and available from Apple Computer, Inc. of Cupertino, Calif. The CPU 36 utilizes an operating system that, depending on the hardware used, may be any number of possible operating systems such as “WINDOWS XP”, “LINUX”, “MAC OSX”, or any other suitable operating system. The CPU 36 executes the fetched computer instructions of the form table system 100, enabling the CPU 36 to retrieve data or write data to the primary storage 30, display information on one or more display devices 24, receive command signals from one or more input devices 26, or transfer data to secondary storage 32 or even other computer systems which collectively form a computer network. Those skilled in the art understand that the primary storage 30 may include any type of non-volatile storage, such as a small computer systems interface (SCSI) drive, a Winchester fixed disk drive, and the like. Likewise, the secondary storage 60 may include RAM, read-only memory (ROM), application specific integrated circuits (ASIC) memory, compact disc (CD) ROM media, magnetic storage media, or optical storage media.

The primary storage 30 stores a number of items including the form table system 100 and a runtime environment 46. The runtime environment 46 typically is an operating system, which manages computer resources, such as memory, disk, and processor time. The runtime environment 46 may also be a message-passing system, a microkernel, one or more dynamic loadable linkable modules (DLLs), or any other system to manage computer resources.

A preferred method of the invention creates forms in QDF format. QDF is a proprietary file format developed by Ringler Informatik AG of Zug, Switzerland. The QDF format represents two-dimensional documents in a resolution- and device-independent manner. Like files created under the PDF format, each QDF file encapsulates a more complete description of a two-dimensional document than is found in a typical text document. Like PDF files, QDF files typically include text, fonts, images, and two-dimensional vector graphics that compose the document.

QDF is a font-embedding/replacement system that allows fonts to travel with documents. It includes an object layer of vector-based data input components. QDF may be considered a structured data layer representing corresponding data is a structured way. A QDF file is thus essentially a structured storage system, which bundles elements and any associated images into a single file, with data compression where appropriate. A QDF document resides in a single file and supports true object transparency.

Like PDF files, QDF files do not encode information that is specific to the application software, hardware, or operating system used to create or view the document. This feature ensures that a valid QDF form is rendered in exactly the same manner, regardless of its origin or destination. Therefore, the QDF file format is ideally suited for the tables created using the form table system 100 and method 200 of the present invention.

A QDF reader and form filler, known as Snapform Viewer, employs a font-substitution strategy. Snapform Viewer is a product of Ringler Informatik, AG, of Zug, Switzerland. Because of the font-substitution feature, a document created by the Snapform Viewer is readable even if an end-user receiving the document does not have the fonts that are employed within the document. QDF also allows font-embedding, to ensure that the proper fonts are displayed. While font-embedding and font-substitution are available with other products, such as PostScript, PostScript files are not normally distributed freely because of font licensing agreements that restrict such distribution. PostScript is a page description and programming language of Adobe Systems Incorporated, of San Jose, Calif.

In some embodiments, the form table system 100 is made up of several components, namely, Visual Form Designer Software, Form Design objects, Table Container Control, Input field controls, and other dynamic/static controls, like labels, barcodes, and Form Filler Software.

In an advantage, the form table system 100 provides a mechanism by which a user may rapidly create tables with minimal effort. Objects need not be lined up along either a horizontal or a vertical axis, but may be placed anywhere within the table object. Where the entries in the form table exceed a predetermined number of rows, the form table system 100 automatically generates additional pages of the form table, such that the original document including the form table is presented in the same manner, whether the form table is populated with a large number of entries or not.

In another advantage, the form table system 100 provides a mechanism by which a user may create tables, fixed over a background image, which are limited in size to a particular grid yet permits flexibility in creating input fields for inputting data in a table having essentially an unlimited number of rows.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A software program (100) executable to generate a form table (50) comprising a predetermined number of visible cell array vectors (84), the software program (100) comprising:
a plurality of objects (66), each of the plurality of objects (66) being selectable by an input device (26); and
a form section (72) to receive one or more objects of the plurality of objects (66), the one or more objects to define a cell array vector (90) of the form table (50), wherein the form table (50) is to be populated with an entered number of cell array vectors (110);
wherein the form table (50), when presented, comprises the predetermined number of visible cell array vectors (84), independent of whether the entered number of cell array vectors (110) exceeds the predetermined number (84) or not.

2. The software program (100) of claim 1, the plurality of objects (66) further comprising:
a table object (66a) to be presented to the form section (72), wherein the one or more objects (66) defining the cell array vector (90) of the form table (50) are disposed within the table object (66a).

3. The software program (100) of claim 2, further comprising:
an object property section (78) specifying one or more characteristics (58) of each of the plurality of objects (66), the one or more characteristics (58) being selectable by the input device (26), wherein the predetermined number of visible cell array vectors (84) comprises one characteristic (58) of the table object (66a).

4. The software program (100) of claim 3, further comprising:
a plurality of selectable icons (76), each icon associated with an object of the plurality of objects (66), the icons (76) being selectable by the input device (26).

5. The software program (100) of claim 1, further comprising:
a scroll bar (94) presented adjacent to the form table (50) when the predetermined number of visible cell array vectors (84) is greater than one and the entered number of cell array vectors (110) exceeds the predetermined number of visible cell array vectors (84), the scroll bar being selectable by the input device (26) to scroll the cell array vectors (90) of the form table (50) such that cell array vector(s) (90) not presented be viewable, such that the predetermined number of visible cell array vectors (84) is maintained.

6. The software program (100) of claim 5, wherein information (92) entered into the form table (50) is selectable to be printed as an additional table listing (88) when the entered number of cell array vectors (110) exceeds the predetermined number of visible cell array vectors (84).

7. The software program (100) of claim 5, wherein the form table (50) is printed in original form with information (92) entered into the form table (50) when the entered number or cell array vectors (110) is less than or equal to the predetermined number of visible cell array vectors (84).

8. The software program (100) of claim 1, further comprising:
a phantom table button (96) presented adjacent to the form table (50) when the predetermined number of visible cell array vectors (84) is one and the entered number of cell array vectors (110) exceeds one, the phantom table button (96) being selectable by the input device (26) to scroll the cell array vector (90) of the form table (50) such that the cell array vector(s) (90) not presented be viewable, such that the predetermined number of visible cell array vectors (84) is one.

9. The software program (100) of claim 8, further comprising:
a phantom table (98) viewable when the phantom table button (96) is selected by the input device (26), the phantom table (98) including the cell array vector(s) not presented in the form table (50).

10. The software program (100) of claim 1, wherein one object of the plurality of objects (66) is selected from a group consisting of a line, a rectangle, a cover, an image, a label, a hyperlink, an information point, a text field, a numeric field, a date field, a masked input field, a multiple line text field, a checkbox field, a combination box field, a password field, a radio buttons group, a table field, and a barcode field.

11. The software program (100) of claim 3, the object property section (78) further comprising:
a horizontal row direction checkbox (68) selectable using the input device (26), wherein the horizontal row direction checkbox (68) determines whether the cell array vectors (90) of the table object (66a) are presented vertically or horizontally.

12. The software program (100) of claim 1, the one or more objects comprising a first object (66) and a second object (66), wherein the first object (66) and the second object (66) are not aligned on either a horizontal or a vertical axis within the form section (72).

13. A method (200), comprising:
opening an application having a form section (72);
arranging one or more objects (66) in a form section (72), the objects (66) comprising features of a cell array vector (90) of the form table (50); and
specifying a number of visible cell array vectors (84) for the form table (72);
wherein the form table (50) comprises identical cell array vectors (90), each cell array vector comprising the one or more objects (66) as arranged in the form section (72), the number of presentable cell array vectors being equal to the number of visible cell array vectors.

14. The method (200) of claim 13, further comprising:
arranging a table object (66a) within the form section (72); and
arranging the one or more objects (66) within the table object (66a).

15. The method (200) of claim 14, further comprising:
specifying a cell array vector height (82) of the cell array vector (90); wherein the form table (50) comprises the identical cell array vectors (90) each cell array vector having the cell array vector height (82).

16. The method (200) of claim 13, specifying a number of visible cell array vectors (84) further comprising:
accepting a default value for the number of visible cell array vectors (84).

17. The method (200) of claim 13, further comprising:
entering data (92) in cell array vectors (90) of the form table (50), wherein the number of visible cell array vectors (84) is one and the number of entered cell array vectors (110) exceeds one; and
displaying the form table (50) on a display device (24); wherein a phantom table button (96) is disposed next to the form table (50), the phantom table button (96) being selectable by the input device (26) to view additional entered data (92) not currently visible on the display device (24).

18. The method (200) of claim 17, further comprising:
printing the form table (50) as an additional table listing (88), wherein the form table (96) includes an indicator (112) referring to the additional table listing (88).

19. The method (200) of claim 13, further comprising:
entering data (92) in cell array vectors (90) of the form table (50), wherein the number of visible cell array vectors (84) is greater than one and the number of entered cell array vectors (110) exceeds the number of visible cell array vectors (84); and
displaying the form table (50) on a display device (24);
wherein a scroll bar (94) is disposed next to the form table (50), the scroll bar (94) being selectable by the input device (26) to view additional entered data (92) not currently visible on the display device (24).

20. The method (200) of claim 17, further comprising:
printing the form table (50) as an additional table listing (88), wherein the form table (96) includes an indicator (112) referring to the additional table listing (88).

21. An article comprising a medium for storing a software program, the software program comprising the following steps:
opening an application having a form section (72);
arranging one or more objects (66) in a form section (72), the objects (66) comprising features of a cell array vector (90) of the form table (50); and
specifying a number of visible cell array vectors (84) for the form table (72);
wherein the form table (50) comprises identical cell array vectors (90), each cell array vector comprising the one or more objects (66) as arranged in the form section (72), the number of presentable cell array vectors being equal to the number of visible cell array vectors.

22. The article of claim 21, the steps further comprising:
arranging a table object (66a) within the form section (72); and
arranging the one or more objects (66) within the table object (66a).

23. The article of claim 22, the steps further comprising:
specifying a cell array vector height (82) of the cell array vector (90); wherein the form table (50) comprises the identical cell array vectors (90) each cell array vector having the cell array vector height (82).

24. The article of claim 21, the steps further comprising:
accepting a default value for the number of visible cell array vectors (84).

25. The article of claim 21, the steps further comprising:
entering data (92) in cell array vectors (90) of the form table (50), wherein the number of visible cell array vectors (84) is one and the number of entered cell array vectors (110) exceeds one; and
displaying the form table (50) on a display device (24);
wherein a phantom table button (96) is disposed next to the form table (50), the phantom table button (96) being selectable by the input device (26) to view additional entered data (92) not currently visible on the display device (24).

26. The article of claim 25, the steps further comprising:
printing the form table (50) as an additional table listing (88), wherein the form table (96) includes an indicator (112) referring to the additional table listing (88).

27. The article of claim 21, the steps further comprising:
entering data (92) in cell array vectors (90) of the form table (50), wherein the number of visible cell array vectors (84) is greater than one and the number of entered cell array vectors (110) exceeds the number of visible cell array vectors (84); and
displaying the form table (50) on a display device (24);
wherein a scroll bar (94) is disposed next to the form table (50), the scroll bar (94) being selectable by the input device (26) to view additional entered data (92) not currently visible on the display device (24).

28. The article of claim 25, the steps further comprising:
printing the form table (50) as an additional table listing (88), wherein the form table (96) includes an indicator (112) referring to the additional table listing (88).
